(19) United States
(12) Patent Application Publication
(10) Pub. No.: US 2009/0035427 A1
(43) Pub. Date: Feb. 5, 2009

(54) Sweet tea composition without use of natural or artificial sweeteners

(76) Inventor: Ronald Tyler Rubin, Clayton, MO (US)

Correspondence Address: MCDERMOTT, WILL & EMERY LLP;Attn: IP Department, 227 WEST MONROE STREET, SUITE 4400, CHICAGO, IL, 60606-5096, US

(21) Appl. No.: 11/888,665

(22) Filed: Aug. 1, 2007

(51) Int. Cl. A23F 3/14; A23F 3/30

(52) U.S. Cl. 426/302; 426/597

(57) ABSTRACT

A sweet tea product, and a process for the preparation of that sweet tea product. The process comprises blending tea leaves with sweet blackberry leaves to create a tea leaf and blackberry leaf blend, and then steeping the tea leaf and blackberry leaf blend in a solvent, to extract flavor components of both leaves. The solvent is preferably water. The resulting sweet tea is advantageous, in that it has the characteristic high sweetness of sweet tea, yet is made without the addition of either artificial or natural sweeteners.

### CROSS-REFERENCE TO RELATED APPLICATIONS

None.

### FEDERALLY SPONSORED RESEARCH OR DEVELOPMENT

Not Applicable.

### TECHNICAL FIELD

The present invention relates generally to a so-called sweet tea, and a method of making that sweet tea, without the need for either artificial or natural sweeteners.

### BACKGROUND OF THE INVENTION

According to published sources, “sweet tea” is a form of iced tea in which a high amount of sugar or some other form of natural or artificial sweetener is added to the water. As a result of the addition of the large amount of sugar or other natural or artificial sweetener, sweet tea has a sweetness that dominates and overwhelms the somewhat bitter taste of the common, unsweetened tea drink.

In the conventional manufacture of sweet tea, the sugar or sweetener is added to the hot water before, during, or shortly after high temperature brewing. In any event, in connection with the prior art methods of making sweet tea, the sugar or sweetener is always added before the beverage is chilled and served. Sweet tea is a highly popular drink in the Southern United States. In fact, in the South, the word “tea” is virtually synonymous with cold, sweet tea, and is not generally understood to refer to either unsweetened iced tea, or to hot tea.

Typically, sweet tea in the South is made in large quantities, i.e., several gallons or more, quickly and inexpensively. It is usually consumed daily as a staple soft drink.

There is no standard manner of making Southern-style sweet tea. In addition, the recipe for sweet tea varies from household to household. There are variations in the amount of tea used, the time during which the tea is steeped, whether or not the tea is boiled, and even in the amount of sugar or artificial sweetener added. Nevertheless, a typical way of making sweet tea comprises bringing water to a boil, and then adding tea to the water, for steeping. Commonly, the tea is generally the dustings or fannings of Orange Pekoe, bought specifically in cheap tea-bag form as an “iced tea” blend. The amount of tea used per volume of water varies, but is typically one-third to one-half of the amount of tea that is used in connection with the manufacture of a conventional, more traditional hot tea.

With some varieties of tea, boiling the water is disfavored, as boiling of the tea tends to increase its characteristic bitterness. In any event, after the steeping process is completed, the sugar or other natural or artificial sweetener may be added to the tea/water container.

As noted above, the amount of sugar or artificial sweetener may vary. Typical, however, is the addition of one full cup of sugar per half gallon of tea. Some users will use even more sugar. Obviously, the addition of such a high amount of sugar is less than ideal for those concerned with weight control, or with other dietetic concerns related to the consumption of high amounts of carbohydrates and unrefined sugars.

Other home brewers of sweet tea will reduce the amount of sugar added per a given volume of tea. However, to achieve the same level of sweetness, such brewers also add an artificial sweetener to the tea. For example, some users can add, to a half gallon of tea, one-half cup of sugar and one-half cup of Splenda brand artificial sweetener. While this solves one problem, it potentially creates another. Specifically, artificial sweeteners have an arguably mixed safety record, with the large consumption of such sweeteners by test animals occasionally associated with increased rates of diseases. Accordingly, there is currently no ideal way of manufacturing a sweet tea product.

As alluded to above, whether the sweet tea is manufactured with pure sugar alone, artificial sweetener alone, or a sugar/artificial sweetener blend, the end result is a tea in which the “sweet” factor overpowers the tea-taste factor, and its characteristic bitterness.

Nevertheless, in view of the undesirability of using such high amounts of sugar, artificial sweeteners, or blends of sugar and artificial sweeteners in sweet tea, it would be desirable to produce a tea having the characteristic, extremely sweet flavor of sweet tea without using either sugar or an artificial sweetener.

Prior art includes so-called Chinese “sweet tea.” This Chinese “sweet tea” is different from American “sweet tea.” Particularly, Chinese “sweet tea” is not really a tea at all, in the American sense. Rather, the Chinese “sweet tea” is made by steeping the leaves of the Chinese blackberry bush (Rubus Suavissimus S. Lee). These leaves are also known as “sweet blackberry leaves.” This Chinese “sweet tea” contains a natural sweetener, known as Rubusoside. Rubusoside can be and has been extracted from the leaves of the Chinese blackberry bush, and it has 200-300 times the sweetness of cane sugar.

It is an object of the invention to make a typical American “sweet tea” product without the addition of natural or artificial sweeteners, and which product is low in calories, making this sweet tea drink an ideal drink for the calorie-conscious consumer.

Patents and Published Applications known to the applicants and relating to fermented and tea drinks, and related technologies and products, include U.S. Pat. Nos. 2,712,998; 4,851,252; 5,496,553; 6,228,996; and United States Patent Application Publication Nos. US 2005/0152997 A1 and US 2005/0202145 A1.

### SUMMARY OF THE INVENTION

The invention is a sweet tea product, comprising the extracts of tea leaves (Camellia sinensis) and the extracts of sweet blackberry leaves (Rubus Suavissimus S. Lee). Typically, the extracts of the tea leaves and the sweet blackberry leaves are obtained from a steeping process. More particularly, the tea leaves and the sweet blackberry leaves are combined to form a blend, and then this blend is steeped to create the “sweet tea” product. This blend may be packaged, in either tea bags, tins, bulk bags, or in any other suitable container. After packaging, the blend has a shelf life of up to two years.

Virtually any conventionally processed tea leaves can be used, including but not limited to black tea leaves, green tea leaves, Oolong tea leaves, or white tea leaves.

The significant advantage of the sweet tea product made in accordance with the present invention is that it can be made without the addition of any amount of sugar or artificial sweeteners.

The process of making the present sweet tea product comprises blending tea leaves with sweet blackberry leaves, to create and tea leaf and blackberry leaf blend, and then steeping the tea leaf and blackberry leaf blend in a solvent.

The solvent is preferably water.

In order to make the sweet tea product of the present invention, the amount of tea leaves will comprise between 40% and 70% (by weight) of the total weight of the blend. The amount of sweet blackberry leaves in the blend will comprise between 30% and 60% (by weight) of the total weight of the blend.

An ideal blend comprises 60% tea leaves, and 40% sweet blackberry leaves.

### DETAILED DESCRIPTION

As discussed above, for the purposes of this invention, “sweet tea” is a drink made from steeping a blend of tea leaves and sweet blackberry leaves. In essence, the “sweet tea” of the invention comprises the extracts of tea leaves and the extracts of blackberry leaves. Typically, the tea leaves are combined with blackberry leaves to form this blend. This blend is then steeped, preferably in very hot and occasionally in boiling water, to create the “sweet tea” product.

Preferably, the blackberry leaves are sweet blackberry leaves. Any suitably processed tea leaves can be used, including but not limited to black (or fermented) tea leaves, green (or unfermented) tea leaves, Oolong (or semi-fermented) tea leaves, or white tea leaves. The tea leaves are processed in accordance with conventional techniques.

For example, in order to process black tea, the leaves are plucked and treated in a four-step process. In the first step, withering is used to remove moisture from the freshly plucked leaf. Withering permits the leaves to be rolled. The leaves are then spread on trays or racks, and in a cool room, for 18 to 24 hours. Because of evaporation during this period of time, the leaves lose one-third to one-half of their moisture, and become soft and pliable.

A rolling step breaks the cells of the leaf. This releases enzymes that will interact with air and cause oxidation, i.e., fermentation. In the fermentation step, the chemical structure of the leaf is changed, and key flavor characteristics are released. The rolled leaves are spread on cement or tile floors and tables in a cool, humid room. They are carefully monitored for the next one to five hours for proper color and pungency.

A fourth or firing step stops the fermentation. The leaves are placed in hot pans similar to woks, or in large modern dryers where a constant temperature of 120 degrees F. can be maintained. The leaves turn black, and lose 97% of their original moisture. Finally, the tea is sorted, graded, and packed in wooden chests that have been lined with foil to prevent the intrusion of unwelcome flavors and aromas.

Green tea leaves are manufactured in three stages, all completed in a single day. Pan firing or steaming occurs immediately after the leaves have been removed from the tree. The leaves a placed in a metal pan, and over a hot flame, to render them soft and pliable. This exposure to heat destroys enzymes that would otherwise lead to oxidation. The leaves are next rolled manually, on heated trays, in order to reduce their moisture content. The final drying step comprises firing, in large mechanical dryers. After the completion of the firing step, the green tea leaf has lost 98% of its moisture. Some green teas produced for export are rolled and fired several times. The green tea is then sorted by leaf size, and packed.

The processing of Oolong tea combines elements of both fermented and unfermented processes. The processing of the leaves begins immediately after they are picked. In the processing of Oolong tea, the withering and fermentation steps are combined. Particularly, the leaves are placed in direct sunlight for a total of about four to five hours. The leaves are spread three or four inches deep, in large bamboo baskets, and shaken frequently. This shaking bruises the leaf edges, which bruising causes the edges to oxidize faster than the leaf centers. This stage is halted when the leaves give off a characteristic fragrance, similar to that of apples or orchids or peaches. The next stage is a firing stage, during which leaves in baskets are moved into and out of the flames of a charcoal fire. Finally, the tea is sorted for size and color, and packed into foil-lined wooden chests for transport.

White tea is only minimally processed. The immature tea leaves are picked shortly before buds have opened. Leaves are plucked and steamed immediately. White tea does not undergo fermentation or oxidation.

The sweet blackberry leaves are plucked from their bush, and dried. The drying of the blackberry leaves is done in generally the same manner as the drying of tea leaves.

After the above processing steps, the tea leaves and the sweet blackberry leaves are cut in a manner that makes them more suitable for steeping or brewing. Preferably, the leaves may be cut in two different manners, i.e., in either the “teabag cut” or the “leaf cut.”

The “teabag cut” is referred to as “fannings grade,” and has a density of between 90 milliliters/50 grams, and 150 milliliters/50 grams.

“Leaf cut” is referred to as pekoe, orange pekoe, and broken orange pekoe grades, and has densities ranging from 130 milliliters/50 grams to 190 milliliters/50 grams.

In creating the leaf blend of the invention, a “teabag cut” or a “leaf cut” may be used. However, it is preferable that “teabag cut” and “leaf cut” leaves not be combined. In addition, “teabag cut” leaves are preferably the only teas that should be used for filling tea bags.

More particularly, tea leaves are processed into “leaf cut” or “teabag cut” products by one of two different methods.

In the first method, known as “orthodox” manufacture, the leaves are processed to form the “leaf cut” product. The traditional, or “orthodox” procedure is the process generally used to make loose tea. In this process, the leaves are subjected to a process of withering, rolling, oxidation, and drying. The details of the four-step “orthodox” process are well-known in the art, and are described in any of a number of prior art publications.

In the second method, i.e., the cut, tear, and curl (“CTC”) method, the “teabag cut” product is formed. In the CTC method, the tea is shredded by passing the leaves between two rollers with metal teeth, each moving in an opposite direction, and at a different speed.

In connection with the blend used to manufacture the sweet tea of the invention, either the “orthodox” or CTC cut tea may be used. However, as noted above, only the CTC cut tea should be placed into tea bags. In manufacturing the blend in accordance with the invention, the amount of tea leaves in the blend will comprise between 40% and 70% by weight of the blend. The amount of sweet blackberry leaves in the blend will comprise between 30% and 60% by weight of the blend.

An ideal blend comprises 60% by weight tea leaves, and 40% sweet blackberry leaves.

When steeping the blends of these individual teas with the sweet blackberry leaves, slightly different temperatures and times should be used. For example, a blend of white tea leaves with the sweet blackberry leaves should be steeped at 175 to 185 degrees F., for approximately 30 to 60 seconds. A blend of green tea with sweet blackberry leaves should also be steeped at 175 to 185 degrees F., but for one to three minutes.

While white and green tea blends should not be boiled, black (or fermented) and Oolong (or semi-fermented) tea blends may be boiled. Accordingly, a black tea/sweet blackberry leaf tea blend should be steeped in water that is at a rolling boil, for about two to five minutes. An Oolong/sweet blackberry leaf blend should be steeped in water that is at a rolling boil for approximately four minutes.

The significant advantage of the sweet tea product made in accordance with the present invention is that it can be made without the addition of any amount of sugar or artificial sweeteners.

The process of making the present sweet tea product comprises blending tea leaves with sweet blackberry leaves to create a tea leaf and blackberry leaf blend, and then steeping the tea leaf and blackberry leaf blend in a solvent, preferably water.

There are two different, generally equally preferred embodiments of making the sweet tea of the invention.

In a first embodiment, tea bags are used, to make approximately one cup of sweet tea. The tea leaf and sweet blackberry leaf blend is prepared in accordance with one of the methods described above. Then, that blend is packaged into a tea bag.

In particular, approximately two grams (total) of the tea leaf and sweet blackberry leaf blend are placed in a tea bag. The blend should comprise approximately 60% tea leaves (1.2 grams) and 40% sweet blackberry leaves (0.8 grams).

The tea bag is steeped in water, in accordance with the time and temperature parameters described above for each of the teas, i.e., white tea, green tea, Oolong tea, or black tea. The finished product is chilled to ice cold temperatures, and served. When consumed, the sweet tea made in accordance with the invention exhibits the extremely sweet taste of Southern-style sweet tea.

A second embodiment is used for the manufacture of larger amounts of sweet tea. In this method, instead of blending tea leaves and sweet blackberry leaves, tea leaves are combined with an extract of the sweet blackberry leaves.

After the dry tea leaves are blended with the extract of the sweet blackberry leaves, the product is dried. Then, if the tea leaves were cut in the “teabag cut” style, the product is placed into round, unbleached teabags.

This method is somewhat less preferable, as it is subject to a slight risk of microbial contamination. Moreover, this product has a shorter shelf life than the product made by the blending and bagging of the tea leaf and sweet blackberry leaf.

Obtaining the extract from the sweet blackberry leaves can be accomplished in ways that are known in the art. As noted above, the extract of sweet blackberry leaves is known as rubusiside. Rubusoside can be and has been extracted from the leaves of the Chinese blackberry bush. Rubusoside has 200-300 times the sweetness of cane sugar.

As one example, the rubusoside extract can be sprayed onto the CTC cut tea leaves. The extract is then allowed to dry on the CTC cut tea leaves, and after drying, packaged in conventional tea bags. These tea bags are steeped in a normal manner to give a highly sweetened tea. The tea is then chilled to ice-cold temperatures and served. Typically, it is necessary to spray approximately 0.1 grams of liquid rubusoside extract onto 2 grams of tea leaves in order to provide sufficient extract to give the ultimately brewed tea the sweet full flavor of sweet tea.

Alternatively, the rubusoside extract can be encapsulated. The capsules of rubusoside are then added to a conventionally brewed, unsweetened or undersweetened tea. In the appropriate amounts, the capsules add sufficient sweetness to the conventionally brewed, unsweetened or undersweetened tea so that it will have the full, sweetened flavor of American style sweet tea. Typically, a capsule containing approximately 0.2 mg of rubusoside extract will be adequate to sweeten one 8 ounce glass of conventionally brewed, unsweetened tea into American style sweet tea. Approximately 16 mg of rubusoside will be adequate to sweeten one gallon of conventionally brewed, unsweetened tea into sweet tea.

The sweet tea of the invention can also be made by inserting a blend of leaf cut tea and sweet blackberry leaves into a pot of boiling water. The relative amounts of tea leaves and blackberry leaves should be between 40% and 70% tea leaves, and between 30% and 60% sweet blackberry leaves. In this instance, ideally, 0.3 ounces of tea leaves and 0.2 ounces of sweet blackberry leaves should be placed in a pot with 2 quarts of water. The tea and blackberry leaf blend is steeped in the boiling or nearly boiling water for various periods of time.

For example, if a combination of black tea and sweet blackberry leaves is used, that combination is steeped for two to five minutes in boiling water.

If a combination of green tea and sweet blackberry leaves is used, that combination is steeped in water of about 185° to 195° for about one to three minutes.

If a combination of white tea and sweet blackberry leaves is used, that combination is steeped in water of about 175° to 185° for about thirty seconds to one minute.

Finally, if a combination of Oolong tea and sweet blackberry leaves is used, that combination is steeped in boiling water for approximately four minutes.

In each case, the leaves are then strained from the liquid tea. The sweet tea is cooled, placed on ice, and then served.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind without significantly departing from the spirit of the invention. Thus, the scope of protection is only limited by the scope of the accompanying Claims.

What is claimed is:

1. A sweet tea product, comprising:
(a) the extracts of tea leaves; and
(b) the extracts of blackberry leaves.

2. The sweet tea product of claim 1, wherein the blackberry leaves are sweet blackberry leaves.

3. The sweet tea product of claim 1, wherein the tea leaves are black tea leaves.

4. The sweet tea product of claim 1, wherein the tea leaves are green tea leaves.

5. The sweet tea product of claim 1, wherein the tea leaves are Oolong tea leaves.

6. The sweet tea product of claim 1, wherein the tea leaves are white tea leaves.

7. A sweet tea product, made without the addition of either artificial or natural sweeteners, said sweet tea product comprising:
(a) the extracts of tea leaves; and
(b) the extracts of blackberry leaves.

8. The sweet tea product of claim 7, wherein the blackberry leaves are sweet blackberry leaves

9. The sweet tea product of claim 7, wherein the tea leaves are black tea leaves.

10. The sweet tea product of claim 7, wherein the tea leaves are green tea leaves.

11. The sweet tea product of claim 7, wherein the tea leaves are Oolong tea leaves.

12. The sweet tea product of claim 7, wherein the tea leaves are white tea leaves.

13. A process for the preparation of a sweet tea product, said process comprising:
(a) blending tea leaves with sweet blackberry leaves to create a tea leaf and blackberry leaf blend; and
(b) steeping the tea leaf and blackberry leaf blend in a solvent, to remove extracts from the tea leaves and the sweet blackberry leaves.

14. The process of claim 13, wherein the solvent is water.

15. The process of claim 13, wherein the blend comprises between 40% and 70% tea leaves, and between 30% and 60% sweet blackberry leaves.

16. The process of claim 13, wherein the blend comprises approximately 60% tea leaves and 40% sweet blackberry leaves

17. A process for the preparation of a sweet tea product, comprising spraying tea leaves with an extract of sweet blackberry leaves to form coated tea leaves, and steeping the coated tea leaves in water.

18. A process for the preparation of a sweet tea product, comprising adding the extract of sweet blackberry leaves to a unsweetened or undersweetened tea.
